(19) United States
(12) Patent Application Publication
(10) Pub. No.: US 2026/0016028 A1
(43) Pub. Date: Jan. 15, 2026

(54) LOCKING SLEEVE FOR AN ACTUATOR

(71) Applicant: Liebherr-Aerospace Lindenberg GmbH, Lindenberg (DE)

(72) Inventors: Markus BILDSTEIN, Oberstaufen (DE); Klaus SCHMELZ, Grünenbach (DE)

(21) Appl. No.: 19/257,057

(22) Filed: Jul. 1, 2025

(30) Foreign Application Priority Data
Jul. 15, 2024 (DE) 10 2024 120 139.8

(51) Int. Cl. F15B 15/26; B64C 13/40

(52) U.S. Cl. CPC F15B 15/264; B64C 13/40; F15B 15/261; F15B 15/1433; F15B 2015/267

(57) ABSTRACT

The present disclosure relates to a device for locking an actuator, preferably a locking sleeve, having two half-shells that are pivotable relative to one another between an open position and a locking position, which are configured in such a way that, in the locking position, the two half-shells are in abutment with each other at their end faces facing each other. The device does not have a bayonet lock, but a web-and-groove connection.

### CROSS REFERENCE TO RELATED APPLICATION

The present application claims priority to German Patent Application No. 10 2024 120 139.8 filed on Jul. 15, 2024. The entire contents of the above-listed application are hereby incorporated by reference for all purposes.

### TECHNICAL FIELD

The present disclosure relates to a locking device, for example a locking sleeve, for a linear actuating apparatus, for example an actuator.

### BACKGROUND

If an actuator, for example a spoiler actuator, fails during flight, flight operations cannot be continued safely unless the actuator is blocked or locked.

### SUMMARY

Against this background, the object underlying the present disclosure is to mitigate or even completely eliminate the problems of the prior art. The object underlying the present disclosure in particular is to provide a device for blocking or locking an actuator, for example a spoiler actuator of an aircraft, in order to be able to continue flight operations in the event of an actuator failure until favorable conditions for actuator repair are present.

This object is achieved by means of a device and a system as described herein.

Accordingly, a device for locking an actuator, optionally a locking sleeve, is provided, comprising two half-shells that are pivotable relative to one another between an open position and a locking position, which are configured in such a way that, in the locking position, the two half-shells are in abutment with each other at their end faces facing each other.

The two half-shells are optionally connected to each other at one end via a hinge so that they are pivotable. At the end opposite the hinge, the half-shells are also optionally in contact in the locking position.

In contrast to conventional solutions with a bayonet lock, the two half-shells may thus form a closed hollow cylinder in the locking position. This also allows full threaded engagement between the device and a housing of the actuator.

In contrast to conventional solutions, a solution according to the disclosure does not have a bayonet lock, but may have a web-and-groove connection.

The device may comprise at least one fixing element by means of which the half-shells can be fixed to each other in the locking position, wherein the fixing element is optionally configured in the form of at least one screw which penetrates a partial region of one half-shell and can be screwed into a partial region of the other half-shell.

According to an embodiment, the fixing element may comprise at least two screws which are configured to hold the two half-shells in abutment at their end faces facing each other.

Furthermore, the device may comprise a thread at least at one longitudinal-side end, which is configured to engage with a further component, optionally an actuator, in order to hold the device releasably to the component.

Furthermore, the device may comprise an anti-rotation means comprising at least one preloaded latch configured to engage in a corresponding recess in a housing in order to prevent the device from twisting relative to the housing.

The at least one latch may be configured in the form of a spring-loaded ball which is adapted to enter a corresponding groove in the housing.

The anti-rotation means may further comprise at least one bushing, in which the ball is guided, wherein the bushing is configured such that it allows the ball to move with and against the spring force.

Another aspect of the disclosure relates to a linear actuating apparatus, optionally an actuator, with a housing, wherein the housing comprises a thread which is configured to engage with a corresponding thread of a device according to the present disclosure.

The housing of the actuating apparatus can be equipped with at least one, optionally multiple radially extending grooves on an end face which is configured to come into contact with the device according to the present disclosure. A ball of an anti-rotation means of the device can enter and/or cross the grooves.

Another aspect of the disclosure relates to a system with a linear actuating apparatus according to the present disclosure and a device according to the present disclosure, wherein the device is in releasable engagement with the housing of the actuating apparatus by means of a threaded engagement at one of its longitudinal-side ends and optionally at least one latch or ball of the anti-rotation means of the device is in engagement with a groove of the housing.

Another aspect of the disclosure relates to the use of a device according to the present disclosure and/or a system according to the present disclosure for manufacturing and/or equipping of an aircraft, for example an airplane.

Furthermore, the disclosure comprises an aircraft, for example an airplane, comprising at least one device according to the present disclosure and/or a system according to the present disclosure.

Another aspect of the present disclosure relates to a method for manufacturing and/or equipping an aircraft, for example an airplane, comprising the step of: placing at least one device according to the present disclosure and/or a system according to the present disclosure on the aircraft, optionally on an actuator thereof.

It should be noted at this point that all features disclosed in the context of a particular embodiment in the present application are also included in any other combinations or even in isolation from the disclosure, although explicit disclosure has been omitted herein for reasons of avoiding redundancy. All features of the disclosure described herein may therefore be claimed in any combination with each other or isolated from each other.

It should also be noted that the terms “one” and “a” do not necessarily refer to exactly one of the elements, although this is a possible configuration, but may also refer to a plurality of elements. Similarly, the use of the plural also includes the presence of the element in question in the singular, and conversely, the singular also includes multiple of the elements in question.

Further details and advantages of the disclosure are explained in more detail with reference to an exemplary embodiment shown in the drawings.

### BRIEF DESCRIPTION OF THE FIGURES

The Figures show in:

FIG. 1: a view of an actuator with a locking sleeve according to the disclosure,

FIG. 2: a detailed view of a section from FIG. 1,

FIG. 3: a sectional view of a locking mechanism of the locking sleeve from FIG. 1, and

FIG. 4: a perspective view of the locking sleeve from FIG. 1 in the open position.

### DETAILED DESCRIPTION

FIG. 1 shows a linear actuating apparatus 1, e.g. a hydraulic cylinder, with a fixed eye 2 and a linearly movable eye 3. A device 4 according to an embodiment of the disclosure is shown, which locks the position of the movable eye 3 relative to the fixed eye 2 in both directions of movement in a form-fitting manner. Locking is achieved by connecting the device 4 to the housing 6 by means of the thread 5, and to the eye 3 by means of the webs 7a and 7b.

In other words, the device may comprise receptacles for webs of the linear actuating apparatus, for example an eyelet thereof, in order to hold the device on the actuating apparatus. Optionally, each half-shell comprises at least one such receptacle.

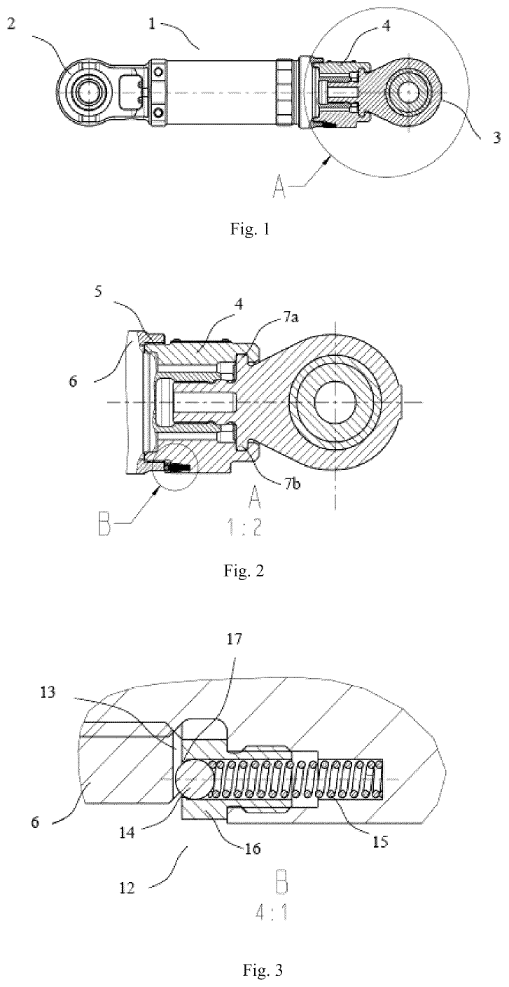

FIG. 2 shows a detailed view of the circled area from FIG. 1.

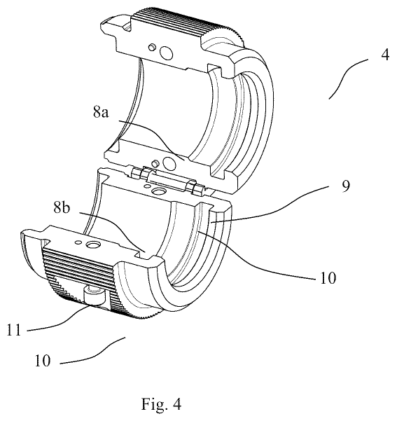

The mountability of the device 4 is ensured in that it consists of two half-shells 8a and 8b, as shown in FIG. 4, for example. For easier handling of the device 4, the two half-shells 8a and 8b are connected by a hinge joint 9.

In the opened state, as shown in FIG. 4, one of the two half-shells 8a or 8b can be placed around the web 7a or 7b of the movable eyelet 3. In preparation for this, it must be ensured that the distance between the movable eyelet 3 and the fixed eyelet 2 is sufficiently large to prevent the thread 5 of the device 4 from colliding with the housing 6 during this process.

By subsequently closing the device 4, the second half-shell 8a or 8b also fits around the web 7a or 7b.

Tightening the two screws 10 prevents the device 4 from opening. By then turning the device 4 about the axis of the thread 5 and simultaneously moving the movable eyelet 3 toward the fixed eyelet 2, the thread 5 is brought into complete engagement, thereby locking the eyelets 2 and 3 relative to one another.

The design of the device 4 shown in the Figures allows it to be turned by hand by providing a non-slip surface 11.

Accidental separation of the threaded connection 5, e.g. due to vibration, is prevented by the rotation lock 12 shown in FIG. 3.

The housing 6 is provided with multiple radially extending grooves 13 on its end face. The device 4 comprises a ball 14 which is loaded by a spring 15.

The bushing 16 prevents the ball from being detached, providing a slightly smaller bore diameter at the end of the bore 17 and also allows the ball 14 to move against the spring force.

As the thread 5 is screwed-in, the ball 14 comes into contact with the end face of the housing 6.

By continuing the screw-in rotation, the ball 14 moves into the device 4 against the spring force, as the device 4 continues to approach the fixed eyelet 2, but the ball 14 can no longer follow this movement due to its contact with the end face of the housing 6.

As the screw is rotated further, the ball 14 will reach one of the grooves 13, causing it to move into the groove due to the spring force.

The grooves 13 are geometrically configured in such a way that increasing the torque of the screw rotation causes the ball 14 to leave the groove 13 again.

As the screw is screwed-in further, the ball 14 will repeatedly move in and out of the grooves 13 until the bushing 16 contacts the front surface of the housing 6. The installation process for the device 4 is now complete.

In this state—with the bushing 16 contacting the end face of the housing 6—the desired prevention of the thread 5 from loosening is yet not highly likely as the ball 14 is unlikely to be located in one of the grooves 13.

However, this is only the case until the ball 14 reaches the groove 13 closest to it as a result of the thread 5 accidentally turning loose. The ball 14 then moves into this groove 13, preventing it from rotating loose any further.

In order to ensure that the device 4 can be dismounted, the grooves 13 are also geometrically configured in such a way that the above-described possibility of further rotation during engagement of the rotation lock by increasing the torque is also possible in the direction of rotation for loosening.

FIGS. 1-4 are shown approximately to scale.

1. A device for locking an actuator, having two half-shells that are pivotable relative to one another between an open position and a locking position, which are configured in such a way that, in the locking position, the two half-shells are in abutment with each other at their end faces facing each other.

2. The device according to claim 1, wherein the device does not have a bayonet lock, but a web-and-groove connection.

3. The device according to claim 1, wherein the device comprises at least one fixing element by means of which the two half-shells can be fixed to each other in the locking position.

4. The device according to claim 3, wherein the at least one fixing element comprises at least two screws, which are configured to hold the two half-shells in abutment at their end faces facing each other.

5. The device according to claim 1, wherein the device comprises a thread at least at one longitudinal-side end, which is configured to engage with a further component in order to hold the device on the further component.

6. The device according to claim 1, wherein the device further comprises an anti-rotation means comprising at least one preloaded latch which is configured to engage in a corresponding recess of a housing in order to prevent the device from twisting relative to the housing.

7. The device according to claim 6, wherein the at least one preloaded latch is configured in the form of a spring-loaded ball which is configured to enter a corresponding groove of the housing.

8. The device according to claim 7, wherein the anti-rotation means further comprises a bushing in which the spring-loaded ball is guided, wherein the bushing is configured such that the bushing allows the spring-loaded ball to move with and against the spring force.

9. A linear actuating apparatus, having a housing, wherein the housing comprises a thread which is configured to engage with a corresponding thread of the device according to claim 1.

10. The linear actuating apparatus according to claim 9, wherein the housing is equipped with at least one radially extending groove on an end face which is configured to come into contact with the device.

11. A system, having the linear actuating apparatus according to claim 9, wherein the device is in releasable engagement with the housing of the linear actuating apparatus by means of a threaded engagement at one of longitudinal-side end of the device.

12. A use of the device according to claim 1 for manufacturing and/or equipping an aircraft, wherein the aircraft is an airplane.

13. An aircraft, comprising at least one device according to claim 1.

14. A method for manufacturing and/or equipping an aircraft, comprising the step: placing the device according to claim 1 on the aircraft, wherein the device is a locking sleeve.

15. The device according to claim 1, wherein the device is a locking sleeve.

16. The device according to claim 3, wherein the at least one fixing element comprises at least one screw which penetrates a partial region of one half-shell of the two half-shells and can be screwed into a partial region of the other half-shell of the two half-shells.

17. The device according to claim 5, wherein the further component is an actuator, and wherein the thread is configured to engage detachably with the further component.

18. The linear actuating apparatus according to claim 10, wherein the at least one radially extending groove comprises multiple radially extending grooves.

19. The system of claim 11, wherein at least one latch or ball of an anti-rotation means of the device is in engagement with a groove of the housing.

20. The method of claim 14, wherein placing the device on the aircraft comprises placing the device on an actuator of the aircraft.
